(19) United States
(12) Patent Application Publication
(10) Pub. No.: US 2021/0342893 A1
(43) Pub. Date: Nov. 4, 2021

(54) System and Method for Shifting Transcript Costs from a Content Supplier to an Advertiser

(71) Applicant: Huseby, Inc., Charlotte, NC (US)

(72) Inventor: Scott Huseby, Charlotte, NC (US)

(73) Assignee: Huseby, Inc., Charlotte, NC (US)

(21) Appl. No.: 16/862,004

(22) Filed: Apr. 29, 2020

(51) Int. Cl. G06Q 30/02; G06Q 50/26; G06K 19/06; G10L 15/26; H04N 5/445

(52) U.S. Cl. CPC G06Q 30/0273; G06Q 30/0254; G06Q 30/0272; H04N 5/445; G06K 19/06037; G10L 15/265; G06Q 50/26

(57) ABSTRACT

A method for shifting transcript costs from a content supplier to a user that includes the steps of transcribing text into a transcription device, transmitting the transcribed text from the stenographic transcription device to a digital store of a computer and providing in the computer an algorithm configured to associate the steno transcribed text with an advertisement for accessing and viewing. The transcribed text is associated with the advertisement and the text and the associated advertisement is delivered to a user's device for display and viewing. The transcribed text may be in document form or captioning displayed for viewing on a video viewing device such as a laptop monitor or television screen.

### TECHNICAL FIELD AND BACKGROUND OF THE INVENTION

The present invention relates to a method for shifting the cost of producing transcripts of the type, for example, generated during legal proceedings, such as depositions, hearings, trials, oral appeal arguments, medical transcripts, related correspondence, events, and the like and also transcripts of the type generated during creation of closed captioning applied to video and television programming. In either case, advertising, promotional content or the like is made available for insertion into transcripts and programming images at a cost to the advertiser or owner of the promotional material. That cost, in the form of a fee, is paid to a content supplier which would typically be one or more of the parties to the proceeding or a program supplier. The cost of the transcript or transcription is thereby transferred to an advertiser or other third party who may perceive a benefit resulting from having the advertising in front of the various parties who may see the transcript either then or at a later date.

As used in this application, the term “advertising” or “advertising content” refers to all of these types of advertising opportunities and placements, including text, graphics, animation, video programming and related audio content. The term “content supplier” as used in this application refers to the originating entity for the transcript, for example, transcript purchasing receiving litigants in a legal action, physicians or similar medical personnel in the medical context, as well as video program and content suppliers and the like. The term “steno’ is used as a shorthand term for “stenograph” or “stenographically.”

Closed captioning is regulated by the Federal Communications Commission, which has established rules (2) Requirements for pre-rule programming. 37 C.F.R. § 79.1 et seq.

In general, video programming distributors must ensure that 75% of pre-rule, nonexempt English language and Spanish language video programming that is being distributed and exhibited on each channel during each calendar quarter is closed captioned. Video programmers must provide closed captioning for 75% of pre-rule, nonexempt English language and Spanish video programming that is being distributed and exhibited on each channel during each calendar quarter. Broadcasters have an obligation to pass through captions of already captioned program and must maintain equipment and monitor for captions. All video programming distributors must deliver all programming received from the video programmer containing closed captioning to receiving television households with the original closed captioning data intact in a format that can be recovered and displayed by decoders meeting the standards of this part unless such programming is recaptioned or the captions are reformatted by the programming distributor.

The term “closed” (versus “open”) indicates that the captions are not visible until activated by the viewer, usually via the remote control or menu option. On the other hand, “open,” “burned-in,” “baked on,” “hard-coded,” or simply “hard” captions are visible to all viewers. As explained in this application, the invention is described in relation to “closed” captioning for purposes of illustration, but is applicable to “open” captioning, as well.

There are two types or formats used for closed captioning. One type involves creating a separate, distinct file that is played in conjunction with a video. The second method consists of embedding closed captioning into the video itself. When closed captioning is created in a separate file, different methods are used. These include binary, text, and XML. Closed captioning and subtitles are similar but different. While subtitles are used to translate a film into another language, they are not geared toward the hearing impaired. Closed captioning includes information beyond the dialogue of a film, like music credits, transcribed sound effects, lyrics to songs, and sometimes the name of the person speaking in a film. Captioning may be simultaneous during, for example, live performances and sporting events, or created for later use.

The invention has particular application to real-time transcription, which is the general term for transcription by, for example, court reporters using transcription machines and real-time text technologies to deliver text to computer screens substantially in real-time (i.e., within a few seconds of the words being spoken). Specialized software allows participants in, for example, court hearings or depositions to make notes in the text and highlight portions for future reference and search within the files for particular terms or phrases, among other features. If the proceeding is video recorded, the video can be synchronized with the text for playback. This type of transcription is becoming more commonly used as computer speed and software sophistication permit more and more accurate transcription using these techniques. As speech recognition software gains in speed and accuracy, it is anticipated that transcripts will more commonly be prepared using direct speech to text software.

U.S. Pat. No. 9,251,790 to Applicant discloses and claims aspects of the invention disclosed in this application. However, technology has changed substantially in the approximately eight years since that application was filed. The purpose of this application is to update the basic concepts disclosed in the '790 patent to take advantage of new technologies in a novel and non-obvious manner.

Many transcript fees including, but not limited to, deposition charges are normally based on a base fee per transcript page, plus extra charges for compressed transcripts, searchable indices, advance ASCII copies and the like. While providing enhanced utility, transcripts using these features are typically substantially more expensive than transcripts that are transcribed and later furnished after editing, proofing, etc.

Similarly, captioning for video is very expensive and mandated by law.

Therefore, in order to lessen costs associated with obtaining these transcripts and captions, there is a need for a system of furnishing transcripts that generates revenue from third parties rather than charges solely to the transcript purchasers. Third party purchasers include, for example, litigation support providers, database providers such as Lexis-Nexis and Westlaw, bar and legal associations, law schools, and the like.

As more broadly envisioned, the system described in this application is not limited to any specific form of transcript creation by capturing spoken words, and anticipates future developments in the field as technology progresses. The system is particularly applicable for use with real-time feeds, i.e., text that is created simultaneously with spoken word and displayed on a screen, stored in digital memory and the like. For example, at a deposition, the resulting rough draft product being prepared in real time can be created with advertising inserted into the text as described in this application, and carried over to the final version of the transcript. Other opportunities include, but are not limited to steno-mask transcription, speech recognition, audio/video transcription, CART (“Communication Access Real-Time Translation”), and medical transcription. The use to which the transcript is put or why it is prepared in the first place is not important, but instead the ability of a content supplier to recoup all or part of the transcription costs by passing that cost to an advertiser.

Also disclosed and claimed is a process and system for embedding captioning including advertising into video captioning. Captioning is embedded in a television signal and becomes visible when decoded in a decoder, either as a separate appliance or built into a television set. The decoder lets viewers see captions, usually at the bottom of the screen that will tell them what is being said or heard on their favorite TV shows. Since 1993, television sets with screens of 13 inches or more that are sold in the United States must have built-in decoders, under the Television Decoder Circuitry Act.

The captions are hidden in the line 21 data area found in the vertical blanking interval of the television signal, which is the area of the television signal that tells the electron gun to shoot back up to the upper left corner of the screen to begin painting the next frame. Line 21 is the line in the vertical blanking interval that has been assigned to captioning (as well as time and V-chip information).

Additional features, aspects and advantages of the invention will be set forth in the detailed description which follows.

### SUMMARY OF THE INVENTION

It is therefore an object of the present invention to provide a system and method of generating revenue by transferring part or all of the transcript cost to content suppliers.

It is another object of the invention to provide an apparatus and method of generating transcription-related revenue by transferring all or part of the transcript cost to third parties.

The methods described in this application may include placing and displaying advertising into a document such as a transcription or caption by transcribing text in real-time in a recording device; communicating the transcribed text to a computer configured to associate an advertisement into the transcribed text; receiving a request from a user to access the transcribed text with the associated advertisement; and communicating the transcribed text with the associated advertisement to a user's peripheral device. In certain aspects, the associated advertisement may be removed from the transcribed text when desired.

The system described in this application may include a computer having a processor, memory, and an advertisement module. The processor is configured to electronically communicate and receive text transcribed from a transcription machine, and is further configured to electronically communicate with the advertisement module. The advertisement module is configured to obtain and associate an advertisement in the transcribed text. The computer's processor is configured to subsequently communicate the transcribed text with the associated advertisement to a user via video. The system is configured to remove the associated advertisement from the transcribed text or change the advertisement when desired.

According to one aspect of the invention, a method for shifting transcript costs from a content supplier to a content user is provided that includes the steps of stenographically transcribing text into a stenographic transcription device, transmitting the stenographically transcribed text from the stenographic transcription device to a digital store of a computer, providing in the computer an algorithm configured to associate the transcribed text with an advertisement for accessing and viewing; associating the transcribed text with the advertisement; and delivering the text and associated advertisement to a user's device for display and viewing.

According to another aspect of the invention, the step of associating the transcribed text with an advertisement includes providing on an image a visible representation of the advertisement.

According to another aspect of the invention, the step of associating the transcribed text with an advertisement comprises creating the transcribed text by voice recognition.

According to another aspect of the invention, the step of associating the transcribed text to an advertisement includes providing the digital representation of the transcript page for viewing with the advertisement and a visible representation of a link that when activated removes the advertisement from viewing on the transcript page.

According to another aspect of the invention, the computer includes an algorithm that permits a user to access the transcribed text with the associated advertisement substantially in real-time.

According to another aspect of the invention, the visible representation of the link includes an image selected from the group consisting of a web domain address, barcode, QR code and an arbitrary image.

According to another aspect of the invention, the computer algorithm includes user-selectable criteria that includes at least one feature selected from the group consisting of advertisement size, page location, advertisement color, time length of display, manner of linking the transcript page to the advertisement and any combination thereof.

According to another aspect of the invention, the algorithm includes the steps of determining and storing digital viewing data representing the number of times the advertisement is viewed and the length of viewing time, calculating a viewing value based upon the digital viewing data and calculating a cost to the advertiser based on the calculated viewing value.

According to another aspect of the invention, the user's viewing device includes a laptop computer, a desktop computer, a tablet, a smart phone, television, video display screen or any combination thereof.

According to another aspect of the invention, the advertisement is changed at a predetermined interval with a different advertisement.

According to another aspect of the invention, the transcribed text includes a caption adapted for being displayed in synchrony with programming content on a video viewing device.

According to another aspect of the invention, the transcribed text is a video caption selected from the group consisting of an open caption and a closed caption.

According to another aspect of the invention, removing the associated advertisement from the transcribed text occurs while copying and pasting the associated advertisement from the transcribed text into a new document, the associated advertisement being removed from the new document having only the transcribed text pasted therein.

According to another aspect of the invention, a system for associating advertising content with transcribed text is provided, and includes a computer having a processor, memory, and an advertisement module for storing advertising content in digital form, wherein the processor is configured to electronically receive steno or voice transcribed text in real time. The processor is configured to electronically communicate with the advertisement module. The advertisement module is configured to digitally associate the digital advertising content with the transcribed text. The processor is configured to electronically communicate the transcribed text with the advertisement to a user's video device.

According to another aspect of the invention, the transcribed text is video captioning and the processor is adapted to simultaneously display the video captioning and the advertisement on a video device.

According to another aspect of the invention, the transcribed text is video captioning and the processor is adapted to disassociate the advertisement from the transcribed text at a predetermined interval and associate the transcribed text with a different advertisement.

According to another aspect of the invention, an algorithm having user-selectable criteria is provided that includes at least one feature selected from the group consisting of advertisement size, page location, advertisement color, time length of display, manner of linking the transcript page to the advertisement and any combination thereof.

According to another aspect of the invention, the algorithm includes the steps of determining and storing digital viewing data representing the number of times the advertisement is viewed and the length of viewing time, calculating a viewing value based upon the digital viewing data and calculating a cost to the advertiser based on the calculated viewing value.

According to another aspect of the invention, the user's video device includes a laptop computer, a desktop computer, a tablet, a smart phone, television, video display screen or any combination thereof.

According to another aspect of the invention, the transcribed text includes a caption and the process is adapted to display the advertising in synchrony with programming content on a video viewing device.

According to another aspect of the invention, the transcribed text is a video caption selected from the group consisting of an open caption and a closed caption.

### BRIEF DESCRIPTION OF THE DRAWING FIGURES

The present invention is best understood when the following detailed description of the invention is read with reference to the accompanying drawings, in which:

FIG. 1 illustrates several deposition pages with indications of the locations where third party advertising may be placed;

FIG. 2 is a schematic diagram illustrating the components and methods for associating advertisements within a transcript;

FIG. 3 is a schematic diagram depicting exemplary components of a computer or tablet configured to associate an advertisement into the transcribed text;

FIG. 4 is a schematic diagram depicting exemplary components used for communicating the transcribed text to a media server so that an advertisement may be associated with the transcribed text;

FIG. 5 is a schematic diagram depicting exemplary components used for obtaining and storing advertisements in a repository;

FIG. 6 is a schematic diagram depicting exemplary steps for associating and disassociating advertisements from a PDF;

FIG. 7 is a schematic diagram depicting an advertisement module configured to associate an advertisement within a PDF;

FIG. 8 is a schematic diagram depicting PDF pages with locations where third party advertising may be placed;

FIG. 9 illustrates an exemplary peripheral device;

FIG. 10 illustrates a printed document, for example, a PDF/a transcript that does not contain advertisements;

FIG. 11 is a flow diagram of an exemplary method of associating advertising content with a transcript;

FIG. 12 is a flow diagram distinguishing legal transcript cost shifting from video-related caption cost shifting; and

FIG. 13 is an illustration showing incorporation of an advertisement as part of a video captioning process.

### DETAILED DESCRIPTION OF THE PREFERRED EMBODIMENT

The invention will now be described more fully with reference to the accompanying drawings in which exemplary embodiments of the invention are shown. Like reference numbers refer to like elements throughout the various drawings.

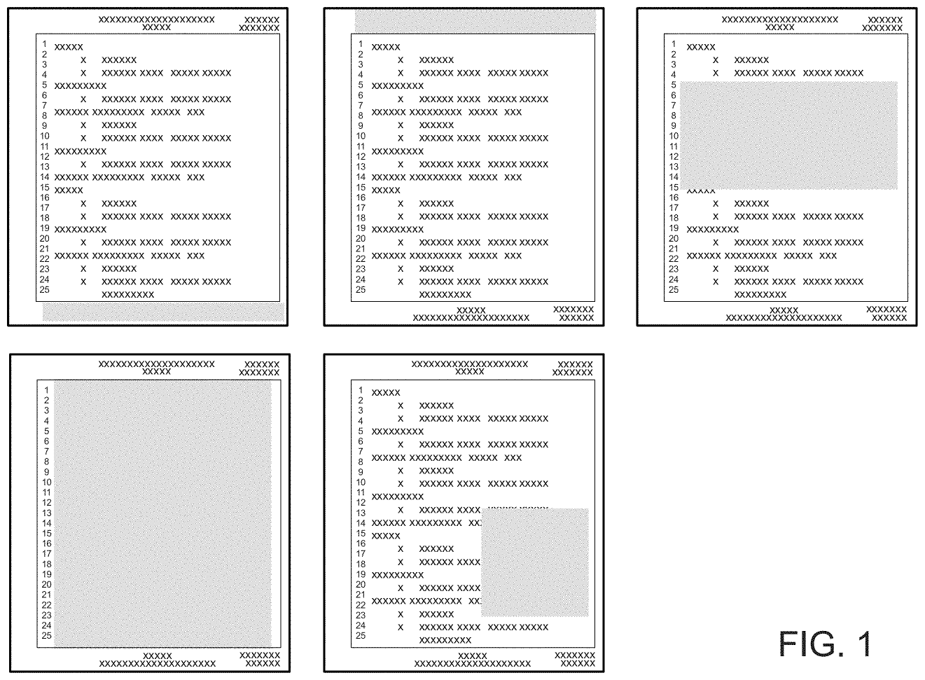

Referring now specifically to FIG. 1, advertising can be placed in any desired location on a particular document page during, for example, a real time feed or a substantially real time feed of an electronically delivered transcribed text. For example, the advertising may be on the cover page, footer, header or text area, and may be size-graduated as a quarter-page, half-page, or full-page—single or double spread.

In certain aspects, the system described herein is format independent or adaptable to various formats. Exemplary formats may include, but are not limited to, Word documents, txt files, PDF files and the like. In certain aspects, Adobe PDF format is a particularly suitable format to serve as a basis for implementation of the system. Such a format, which may be termed PDF/T (“T” for transcript) may be used with a password provided by the service provider (e.g., a court reporting service), and may be convertible when desired into a PDF/A format without the advertising. The PDF/A format may be used, for example, when filing a court document, or for other uses where visible advertising would not be suitable. In additional aspects, the documents having advertisements can be copied and pasted into another document. When this text is copied and pasted into another document, it is preferable to maintain the text's original format such that the advertisements no longer remain in the copied and pasted text.

The system can be offered for sale as a combination of size, percentage transcript coverage, number of pages, hearing advertisements, lines, and duration. For example, a subscriber may choose to purchase the right to place advertisements amounting to 2.5 percent of the space coverage in quarter-page sizes for 100 transcripts, with the fee calculated on the selected combination of size, percentage of coverage and duration.

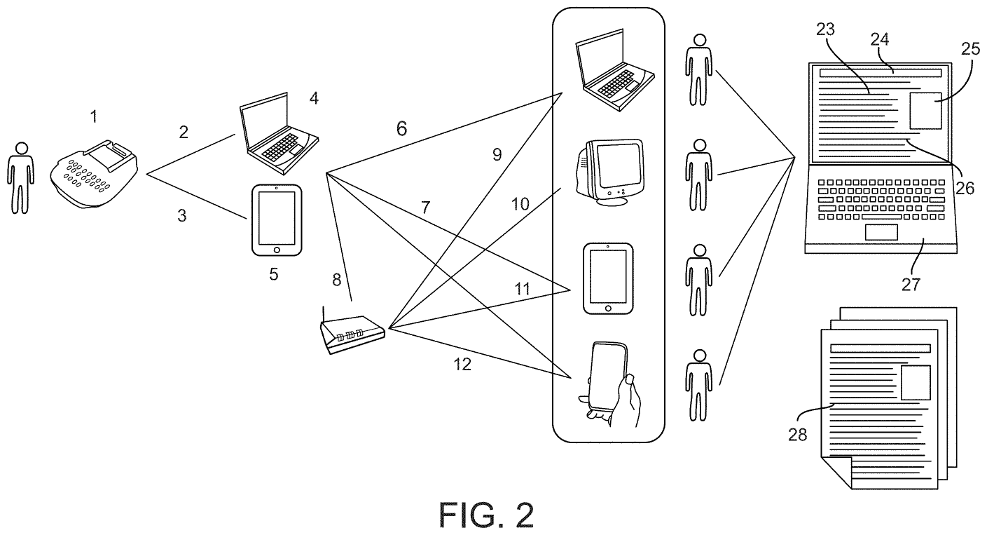

FIG. 2 depicts the systems and methods for placing and displaying advertisements (25) into a document (28). The systems and methods include transcribing text in real-time into a recording device (1). The recording device includes a machine capable of steno-mask transcription, speech recognition, audio/video transcription, CART (“Communication Access Real-Time Translation”), stenotype, or medical transcription. This recording device (1) has memory and/or data storage capacity and is capable of communicating the transcribed text to a computer, remote server, i.e., a cloud-based system, or tablet.

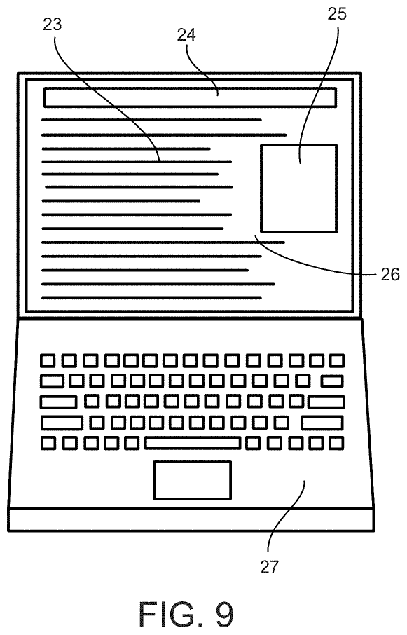

After the text has been transcribed in real-time into the recording device (1), the transcribed text is subsequently communicated (2, 3) to a computer (4) or tablet (5) or hand held device that is configured to convert the transcribed text into a readable medium (23) while also associating an advertisement (25) into the transcribed text. The computer or tablet is configured to receive a request from a user to access the transcribed text with the associated advertisement. The computer or tablet having the transcribed text with an associated advertisement communicates the transcribed text with the associated advertisement either directly to a user's peripheral device (6 and 7) or indirectly via a router (8) to a user's peripheral device (9, 10, 11, and 12), which may include, but is not limited to, a laptop, pod, personal computer, tablet, smart phone, and television, including a “smart” television which connects to the Internet and facilitates “streaming.” For example, FIG. 9 depicts a laptop (27) as the user's peripheral device, which displays the transcribed text (23, 26) with the associated advertisements (24, 25). According to one embodiment, the transcribed text with the associated advertisement is communicated to a user's peripheral device in real-time or substantially in real-time (i.e., within 1 to 60 seconds, 1 to 30 seconds, 1 to 10 seconds, 1 to 5 seconds, or 1 to 3 seconds of the words being spoken and being transcribed by the recording machine).

Alternatively, the transcribed text may be stored for later insertion of advertising content. The transcribed text may be transmitted in such a way that one transcript is sent to one party or a court and contains specific advertising or no advertising, and the same transcript is sent to another party with different specific advertising. The possible combinations and permutations are quite large in complex litigations, and can thus take into account the preferences of various real parties in interest, some of whom may prefer no advertising or advertising of a certain maximum size or content.

In addition, transcribed text may be transmitted for a specific period of time with specific advertising, and/or sent later to other party with either no advertising, or different advertising content.

Codes may be associated in the transcript that delete the advertising after a specified period of time, change the advertising from initial content to later content, expand the footprint of the advertising on a transcript page from a small link to a specified size advertisement upon the occurrence of a specific event such as changing pages when reading on a laptop.

Specified transcript pages may contain a link visible, for example, in a header or footer, that when clicked downloads an advertisement from the Internet. The link may be an actual representation of a domain from which the advertisement is downloaded for viewing, or may alternatively be a code such as a barcode, QR code or similar object. The downloaded content may include an audio file, animated graphics or other similar material.

In accordance with a further preferred embodiment, the computer (4), tablet (5) or other processing device contains an algorithm that permits the user to access a password protected setup screen. After gaining access to a specified, secure area of the system, the setup screen prompts the user to select the ad size and percent coverage, select the advertising art to be uploaded and merged with the transcript, select whether the ad will be displayed in color or black and white, select the page locations, and select the duration, expressed in number of events, number of pages, or another suitable criteria. In addition, the user may prefer custom advertising of its own creation, in which case the advertiser would create the advertising display using provided information regarding size, resolution, format and the like, and upload the advertising in the specified format into the content supplier's server for insertion in the transcript. A user interface may be provided to allow the advertiser to observe the appearance of the advertisement selected on a sample page or pages before a final selection is made. Once the final selection is made, the fee is determined and a charge is made to the advertiser's account, or provision is made for the charge to be paid online with a credit or debit card, or by some other means. The advertisement is merged into the transcript and either printed or prepared for electronic transmission to those transcript purchasers who are willing to pay less for the transcript than for a copy without advertising. This information is stored in a database accessed by the content provider and/or the transcript user.

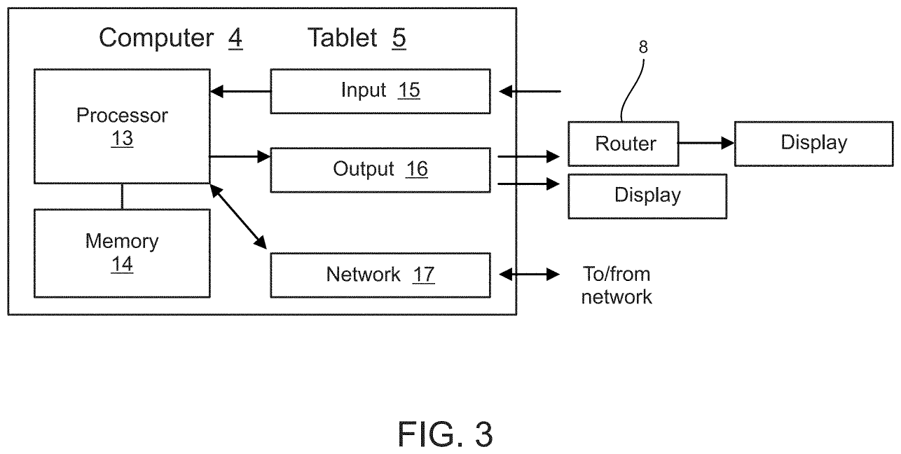

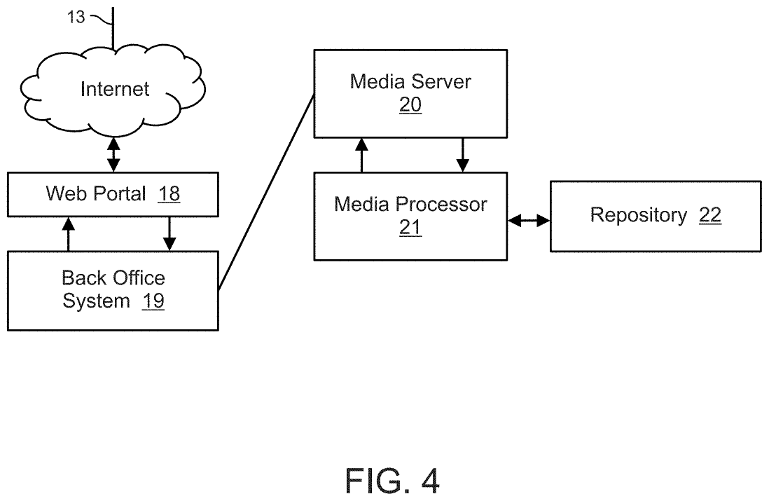

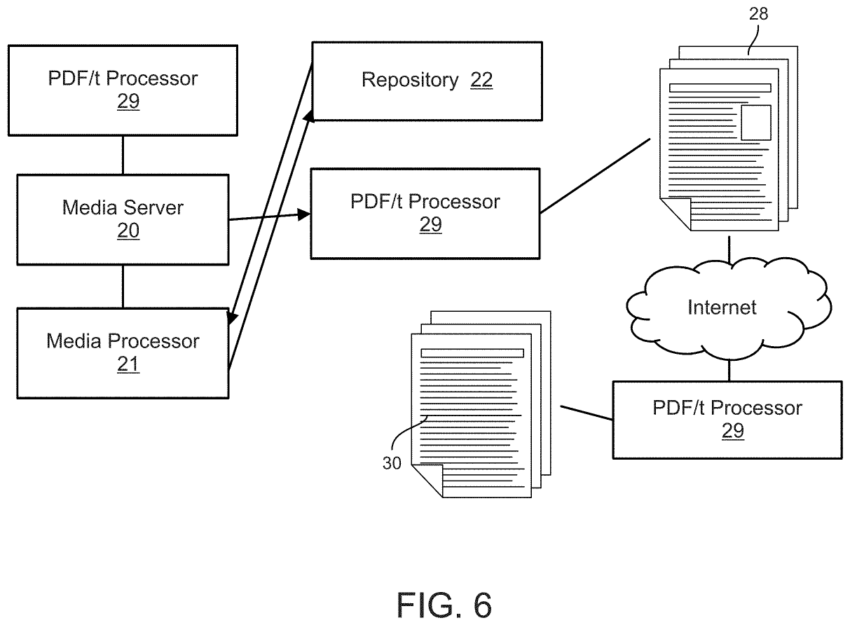

FIG. 3 depicts the components within the computer (4) or tablet (5) configured to convert the transcribed text into a readable medium and merge the readable text with one or more advertisements. Specifically, as shown in FIG. 3, the computer (4) or tablet (5) generally includes an input interface (15), a processor (13), memory (14), a means for connecting to a network (17) (e.g., the Internet and a web portal) for communicating data between the computer (4) or tablet (5) and other devices connected and/or attached directly to the network, and an output interface (16) configured to communicate with an external router (8) or directly with a user's peripheral device (9, 10, 11, and 12). The processor (13) is in communication with the memory (14), input interface (15), output interface (16), and the network (17). Although power, ground, clock, and other signals and circuitry are omitted, it should be understood by one having ordinary skill in the art how to implement these features. The transcribed text is communicated (2, 3) from the recording device (1) to the computer (4) or tablet (5) by the input interface (15). The transcribed text is then received and processed by the processor (13) into a readable medium. The processor communicates the readable text to the network (17), and an advertisement may be associated into the text as depicted, for example, in FIGS. 4 and 6.

In some embodiments, the processor (13) described herein may include a microcontroller or general purpose microprocessor that reads its program from memory (14). The processor may be comprised of one or more components configured as a single unit. Alternatively, when of a multi-component form, the processor may have one or more components located remotely relative to the others. One or more components of the processor may be of the electronic variety including digital circuitry, analog circuitry, or both. In one embodiment, the processor is of a conventional, integrated circuit microprocessor arrangement, such as one or more CORE 2 QUAD processors from INTEL Corporation, or ATHLON or PHENOM processors, One AMD, or POWER6 processors. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

As one step of associating the steno transcribed text to an advertisement, the digital representation of the transcript page may be provided for viewing with the advertisement and a visible representation of a link that when activated removes the advertisement from viewing on the transcript page. Also, the computer may include an algorithm that permits a user to access the steno transcribed text with the associated advertisement substantially in real-time.

The association of the advertising content with the transcript is “virtual” and the visible representation of the link between the advertising content and the transcript may be an active image of a web domain address, barcode, QR code or it may be an arbitrary image behind which resides an active link.

The computer algorithm may also include user-selectable criteria that include advertisement size, page location, advertisement color, time length of display, manner of linking the transcript page to the advertisement and any combination thereof.

The computer algorithm may include the steps of determining and storing digital viewing data representing the number of times the advertisement is viewed and the length of viewing time, calculating a viewing value based upon the digital viewing data and calculating a cost to the advertiser based on the calculated viewing value. For a regular subscriber to this service with an account debiting feature on file, the algorithm can deduct an amount from the account based on the calculated viewing valve and periodically forward statements to the subscriber.

In various embodiments, the memory (14) may include one or more types such as solid-state electronic memory, magnetic memory, or optical memory, just to name a few. By way of non-limiting example, memory (14) can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, a thumb drive, rewritable, or read-only DVD or CD-ROM); a magnetically encoded hard drive, floppy disk, tape, or cartridge medium; or a plurality and/or combination of these memory types. Also, memory (14) may be volatile, nonvolatile, or a hybrid combination of volatile and nonvolatile varieties.

Referring to FIG. 4, upon receiving the transcribed text, the processor (13) of FIG. 3 may connect to the network interface (17) and route the transcribed text through a data network (e.g., the Internet including a web portal (18)) to a media server (20). In certain aspects, “web portals” (18) are any applicable web application server recognized by those skilled in the art configured to route the text described herein to the media server (20). Such web portals may include, but are not limited to, servers built on Zope, J2EE, Zend, or Apache. In certain aspects, the media server (20) is a component of a back office system (19), which includes any applicable application server or database system recognized by those skilled in the art configured to perform the steps described in this application.

After routing the transcribed text through the data network, the media server (20) receives the routed text from the processor (13) and connects to a media processor (21) to associate one or more advertisements within the transcribed text. Upon the media processor receiving the transcribed text, an advertisement retrieving method is used in parallel with the text stream (i.e., the transcribed text received in media processor (21) to retrieve stored advertisement media in digital form from a storage repository (22).

One or more advertisements stored in the repository are selected based upon various criteria including, but not limited to, case types, event types, program types, advertisement type, size, color, location, or any combination thereof. For example, if the transcribed text pertains to a legal document such as a deposition, a legal advertisement within the repository may be selected from a participating third-party legal support provider such as Lexis-Nexis or Westlaw and the advertisement may be subsequently associated with the transcribed text. In certain aspects, the advertisements may include, but are not limited to, still images, hyperlinks, videos, text, audio content, or any combination thereof. In certain embodiments, the advertisements include a PDF file, a Flash file, an HTML file, a ShockWave file, an SVG file, a GIF, a TIF, a JPEG, or any combination thereof. The file type of the text and the advertisement may be the same or different. In certain aspects, the advertisement may further include a tag. The advertisement associated within the text may be identified based on this tag or difference in file type, and the advertisement may be subsequently removed from the text if desired using the methods and systems described herein.

After associating the advertisement with the text, the text associated with the advertisement may then be routed back to the processor (13). The processor (13) subsequently outputs (16) the text associated with the advertisement to a user's peripheral device, and the user's peripheral device displays the text and the associated advertisement. As described above, this text associated with an advertisement may include compressed transcripts, advance ASCII copies and the like having searchable indices and editable text. These electronic documents may be saved on the user's peripheral device for viewing and editing at a later time.

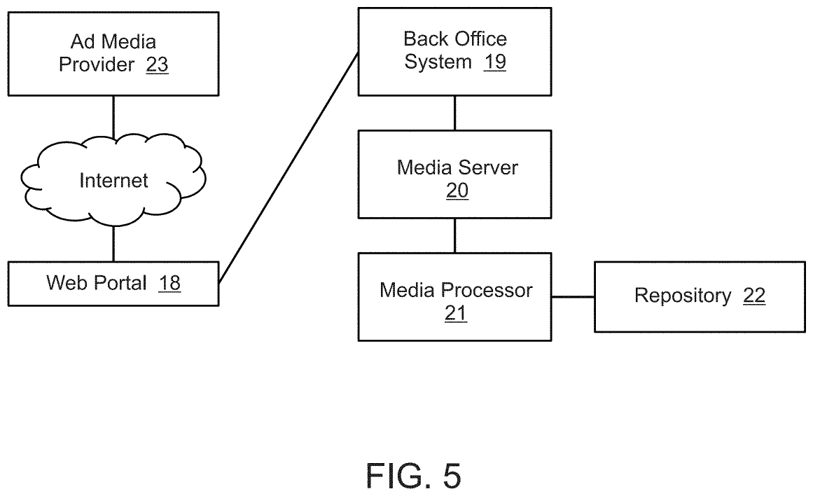

FIG. 5 depicts a schematic illustration in which an ad media provider (23) provides an advertisement to the repository (22) by sending or uploading an advertisement through a web portal (18) interacting with the media server. In certain aspects, the ad media provider includes any third party advertiser or purchaser that has agreed to purchase advertisement space within the transcribed text. Third party purchasers may include, for example, litigation support providers, database providers such as Lexis-Nexis and Westlaw, bar and legal associations, law schools, medical support providers, and the like. In certain aspects, the media server collects the advertisement and communicates the advertisement to the media processor (21). The media processor (21) subsequently catalogs the advertisement by category subject matter type (e.g., litigation, medical, etc.), file type (e.g., PDF file, Flash file, HTML file, ShockWave file, SVG file, GIF, TIF, JPEG, hyperlink, etc.), size, color, etc., and stores the advertisement in the repository until the advertisements are accessed and merged with the transcribed text.

FIG. 6 depicts exemplary steps for associating advertisements with a PDF document. In certain aspects it is desirable to generate a PDF having the advertisements discussed herein, and more particularly, Adobe PDF format is a desired format to serve as a basis for implementation of the system. Such a format, which may be termed PDF/T (“T” for transcript) may be used with a password provided by a service provider (e.g., a court reporting service). In this aspect, the media server (20) may interact with the media processor (21) to obtain an advertisement from the repository (22). One or more advertisements collected based on size, shape, color, and/or location is placed within the PDF/T (28) according to the placement purchased by an advertiser. The user may subsequently print a hard copy of the PDF/T (28). After obtaining the PDF/T and if a copy of the text excluding the advertisement is desired, the user can remove the advertisements in the PDF/T by connecting to the PDF/T processor (29) to access a password. Upon entering the password, the use may select a command to remove the associated advertising. The associated advertisement will be identified by its file type or tag and subsequently removed from the document. A hard copy of the document having a PDF/A format (30) (i.e., a document without the advertising) will be obtained.

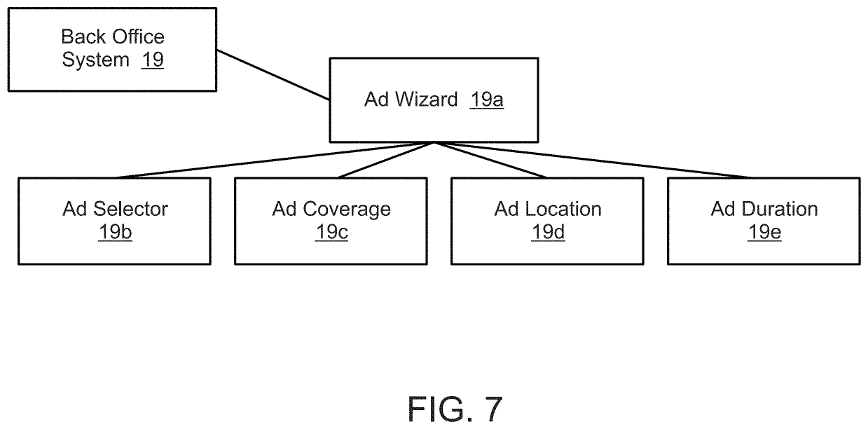

FIG. 7 depicts an advertisement module (19a) configured to select an advertisement for placement within a document. In certain embodiments, the PDF/t Processor connects to the media server (20). The media server (20) interacts with media processor to pull ad media from the repository. In the exemplary embodiments shown in FIG. 7, the back office system (19) uses an ad wizard (19a) or a similar program to process the advertisements being placed into a live real-time feed or PDF/t transcript. In certain aspects, the advertising module “ad wizard” (19a) can selectively interact with various modules including, but not limited to, an ad selector (19b), ad coverage (19c), ad location (19d), and ad duration (19e) either simultaneously or concurrently. For example, the ad wizard (19a) may use an ad selector (19b) to choose an advertisement based on target audience, geographic areas, type of litigation or any other criteria for pairing advertising with an audience. The ad wizard (19a) may further use ad coverage (19c), which uses algorithms to adjust advertisement size and dimensions for placement based on criteria provided. The ad wizard (19a) may further use ad location (19d), which selects the advertisement location inside of the real-time transcript feed or PDF/t transcript for placement based on algorithms and criteria provided. The ad wizard may use ad duration (19e), which sets a time limit on how long the advertisement will be active inside of the real-time transcript feed or PDF/t transcript. In certain embodiments, the back office system (19) indexes the first and last word of a line to maintain the integrity of a transcript.

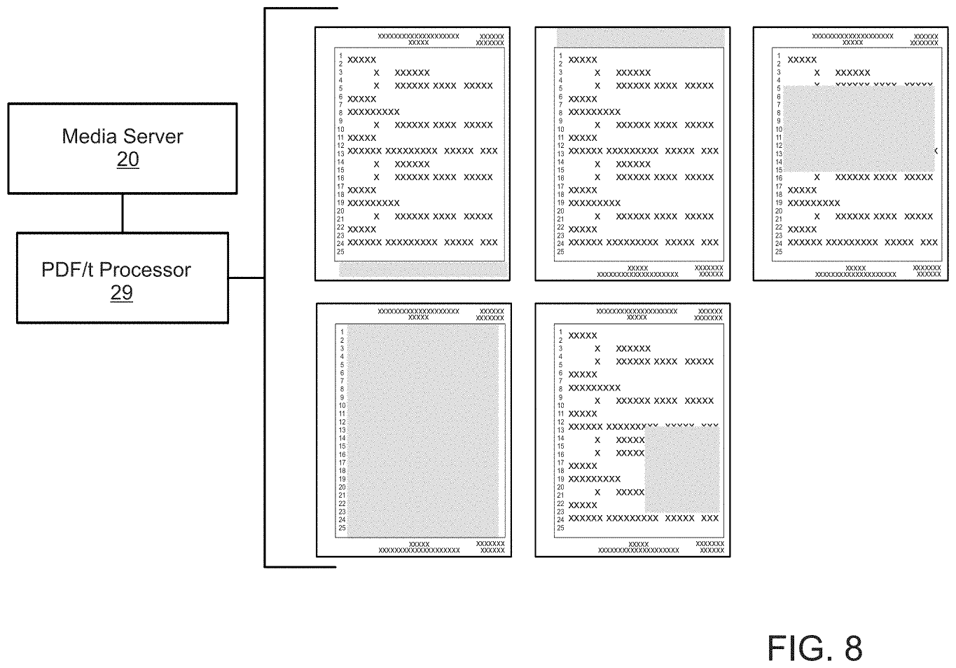

FIG. 8 depicts the media server (20) connecting to the back office system for ad placement within a PDF. When an advertisement is received, the media server (20) interacts with the PDF/t Processor (29) to place advertisements into real-time transcript feed or PDF/t transcript. As previously described above, sponsored links or advertisements are integrated into the context of the real-time transcript feed or PDF/t. In certain aspects, a party placing an advertisement pays a price according to current value for the market space in which it is placed. The media server (20) uses updated transcript lines or sections as input to its algorithms for choosing ads to be displayed in connection with those sections. As described above, the media server (20) connects in parallel with the back office system (19) and responds with ads for placement through PDF/t Processor (29). Advertisements are supplied, updated in direct connection with the display of the transcript in the user interface, and are associated with the PDF/t.

Several advertisers may advertise in the same transcript using software similar to that used to select seats on aircraft to determine location on a first come, first served basis, and the advertisements can be rotated in location throughout the length of the transcript according to predetermined preference. For an additional charge, the advertising can be hyperlinked to the advertiser's website or some other location, and data regarding monthly activity provided to the advertiser using an analytics tool. Advertising can also be charged to the customer on the basis of the number of clicks applied to a particular advertisement, length or viewing among other criteria.

In the litigation context, the computer algorithm also includes a routine that automatically adjusts the transcript line numbers so that, for example, if an advertisement is in the middle of the page, the line numbering proceeds consecutively above and below the advertisement without skipping any line numbers. When the transcript is modified to remove the advertisements, the line numbers shift back into the ordinary location. If necessary, the line numbering of a particular page may shift to a subsequent page while the advertisement is present in order to maintain the integrity of the transcript, permitting the user to copy and paste testimony as usual while maintaining the proper transcript format. The software notes that the transcript includes third party advertising, and the charges to the transcript purchaser is adjusted downwardly according to the content provider's fee schedule. The transcription company can preferably track and quantify the number of users accessing and using the system described herein. The transcription the company can also preferably track and quantify the number of potential users interested in accessing the system described in this application. These tracking numbers can be quantified in any desirable metric including, but not limited to, number of total users per unit of time (e.g., users per day, week, month, or year) and/or the number of advertisements displayed per transcribed subject matter (e.g., related to legal subject matter, related to medical subject matter, related to scholarly subject matter, etc.).

According to one embodiment of the invention, the documents having advertisements can be copied and pasted into another document. When this text is copied and pasted into another document, it is preferable to maintain the text's original format such that the advertisements no longer remain in the copied and pasted text.

FIG. 9 illustrates an exemplary peripheral device.

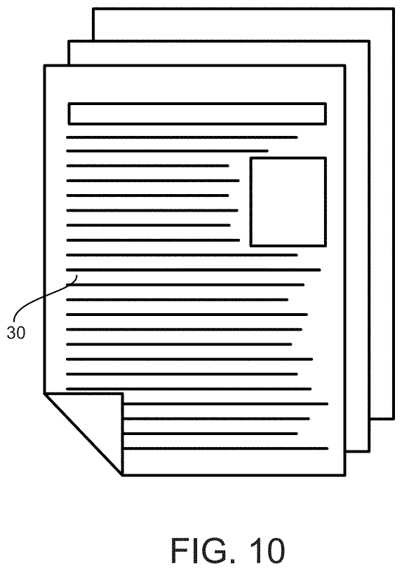

FIG. 10 illustrates a printed document, for example, a PDF/a transcript that does not contain advertisements.

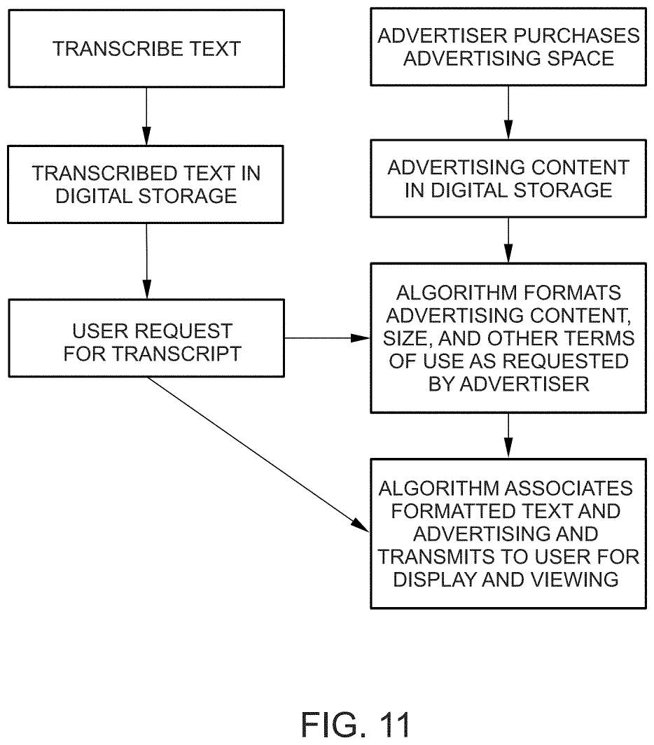

FIG. 11 is a flow diagram of an exemplary method of associating advertising content with a transcript as described above and as claimed.

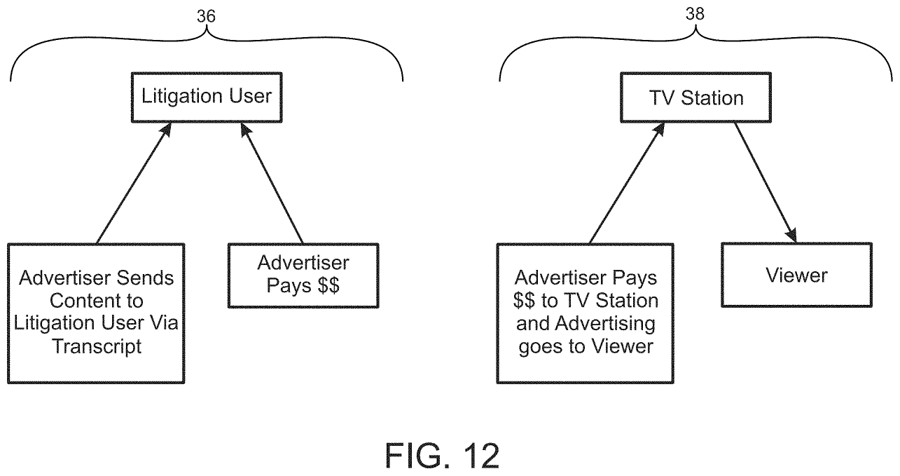

FIG. 12 is a simplified flow diagram that illustrates the difference between cost shifting in, for example, a litigation context (36) where depositions are being created, and in the captioning context. In the litigation context (36), an advertiser pays to have an advertisement placed, for example, in a deposition or trial transcript. The content and the payment go to the litigant and, as well perhaps, to others. Because of the nature of the litigation process, provision must be made for removal of the advertisement under certain circumstances.

In contrast, in the captioning context (38) an advertiser wanting to advertise on, for example, a closed captioned television program pays the content supplier, for example, a television station, and the advertisement is integrated into the caption as it is displayed at the bottom of a television screen. In this instance, the viewer of the programming is the user and the beneficiary of the captioning and is exposed to the advertising. This process provides advantages to all of the relevant parties. The content supplier benefits by being able to recoup at least part of the legally-required cost of providing captioning on most programming. The advertiser benefits by being able to expose viewers to advertising during otherwise non-advertising related programming. The viewer benefits by being able to more easily ignore the advertising being supplied along with the captioning than is the case with advertising segments that interrupt the non-advertising content at intervals.

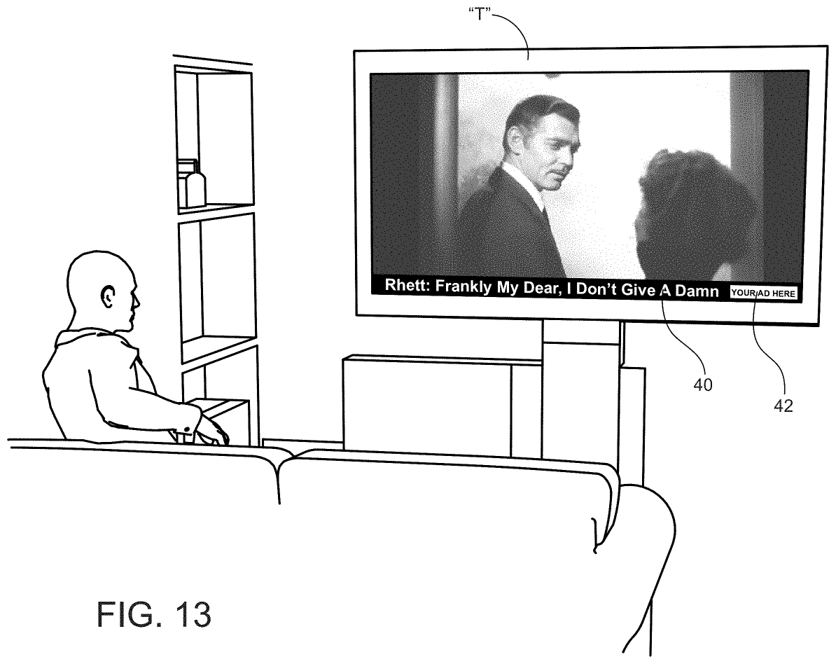

FIG. 13 illustrates in the caption context a closed caption (40), which includes a digital caption segment (42) positioned at the bottom of a television screen “T,” including an advertisement. The advertisement (42) may be part of a digital template onto which the caption (40) is applied. The advertisement (42) may be changed periodically based on advertiser demand for the advertising space, demographic conditions based on time of day, type of content and the like. Alternatively, the advertisement (42) may be an integral part of the caption that loops back onto each display of the caption (40) until removed.

A computer-based apparatus and method for inserting material, such as advertising, promotional materials or public service announcements or postings into transcripts, such as deposition, trial and hearing transcripts, captioning, real-time, and computer generated, among others, according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A method for shifting transcript costs from a content supplier to a content user, comprising the steps of:
(a) transcribing text into a transcription device;
(b) transmitting the transcribed text from the transcription device to a digital store of a computer;
(c) providing in the computer an algorithm configured to associate the transcribed text with an advertisement for accessing and viewing;
(d) associating the text with the advertisement; and
(e) delivering the text and associated advertisement to a user's device for display and viewing.

2. The method of claim 1, wherein the step of associating the text with an advertisement comprises providing on an image a visible representation of the advertisement.

3. The method of claim 1, wherein the step of associating the transcribed text to an advertisement comprises providing the digital representation of image for viewing with the advertisement and a visible representation of a link that when activated removes the advertisement from viewing on the image.

4. The method of claim 1, wherein the computer comprises an algorithm that permits a user to access the transcribed text with the associated advertisement substantially in real-time.

5. The method of claim 4, wherein the visible representation of the link comprises an image selected from the group consisting of a web domain address, barcode, QR code and an arbitrary image.

6. The method of claim 5, wherein the computer algorithm includes user-selectable criteria that includes at least one feature selected from the group consisting of advertisement size, page location, advertisement color, time length of display, manner of linking to the advertisement location and any combination thereof.

7. The method of claim 1, wherein the algorithm includes the steps of determining and storing digital viewing data representing the number of times the advertisement is viewed and the length of viewing time, calculating a viewing value based upon the digital viewing data and calculating a cost to the advertiser based on the calculated viewing value.

8. The method of claim 1, wherein the user's viewing device comprises a laptop computer, a desktop computer, a tablet, a smart phone, television, video display screen or any combination thereof.

9. The method of claim 1, wherein the advertisement is changed at a predetermined interval with a different advertisement.

10. The method of claim 1, wherein the transcribed text comprises a caption adapted for being displayed in synchrony with programming content on a video viewing device.

11. The method of claim 1, wherein the text is a video caption selected from the group consisting of an open caption and a closed caption.

12. The method of claim 1, wherein removing the associated advertisement from the transcribed text occurs while copying and pasting the associated advertisement from the steno transcribed text into a new document, the associated advertisement being removed from the new document having only the transcribed text pasted therein.

13. A system for associating advertising content with transcribed text comprising:
(a) a computer having a processor, memory, and an advertisement module for storing advertising content in digital form, wherein;
(b) the processor is configured to electronically receive transcribed text in real time;
(c) the processor is configured to electronically communicate with the advertisement module;
(d) the advertisement module is configured to digitally associate the digital advertising content with the text; and
(e) the processor is configured to electronically communicate the transcribed text with the advertisement to a user's video device.

14. A system according to claim 13, wherein the transcribed text is video captioning and the processor is adapted to simultaneously display the video captioning and the advertisement on a video device.

15. A system according to claim 13, wherein the transcribed text is video captioning and the processor is adapted to disassociate the advertisement from the transcribed text at a predetermined interval and associate the transcribed text with a different advertisement.

16. A system according to claim 13, and including an algorithm having user-selectable criteria that includes at least one feature selected from the group consisting of advertisement size, page location, advertisement color, time length of display, manner of linking the transcript page to the advertisement and any combination thereof.

17. The system of claim 16, wherein the algorithm includes the steps of determining and storing digital viewing data representing the number of times the advertisement is viewed and the length of viewing time, calculating a viewing value based upon the digital viewing data and calculating a cost to the advertiser based on the calculated viewing value.

18. The system of claim 13, wherein the user's video device comprises a laptop computer, a desktop computer, a tablet, a smart phone, television, video display screen or any combination thereof.

19. The system of claim 13, wherein the transcribed text comprises a caption and the process is adapted to display the advertising in synchrony with programming content on a video viewing device.

20. The system of claim 13, wherein the transcribed text is a video caption selected from the group consisting of an open caption and a closed caption.

21. The system of claim 13, wherein the transcribed text is captured by voice recognition.
